(19) United States
(12) Patent Application Publication
(10) Pub. No.: US 2007/0061593 A1
(43) Pub. Date: Mar. 15, 2007

(54) Sending secured data

(76) Inventors: Ufuk Celikkan, Austin, TX (US); Julianne F. Haugh, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/227,029

(22) Filed: Sep. 15, 2005

(51) Int. Cl. G06F 12/14

(52) U.S. Cl. 713/189

(57) ABSTRACT

Methods, systems, and products are disclosed for sending secured data, the method including encrypting a first portion of a request for computer services to be performed by a downstream node for decryption by a first node, encrypting a second portion of the request for computer services to be performed by a downstream node for decryption by a second node, and passing the request for computer services to a downstream node.

### BACKGROUND OF THE INVENTION

1. Field of the Invention

The field of the invention is data processing, or, more specifically, methods, systems, and products for sending secured data.

2. Description Of Related Art

Many requests for computer services and the corresponding responses may contain sensitive data which passes through multiple nodes from the initial requester to the ultimate destination service provider and back again to the initial requester. The sensitive data for example, may include credit card numbers and the names and addresses of credit card holders intended for a web service that processes credit card transactions. The sensitive data, in this example, may pass from an initial requester through several intermediary web services to an ultimate destination web service that ultimately delivers the web service. Multiple-node transactions in distributed processing environments, such as business integration applications, may also be carried out by passing requests through several nodes from initiation until completion.

Passing sensitive data through multiple nodes presents the risk of revealing the sensitive data to an undesired party. The sensitive data may be intercepted prior to arriving at a downstream node and the data inappropriately disclosed. Similarly, a security compromise in a downstream node properly authorized to receive and view sensitive data may result in the inappropriate disclosure of information. In addition, it may be undesirable to reveal the sensitive data to intermediary parties with no need to view the sensitive data, who merely pass the sensitive data downstream.

One current mechanism for sending secured data suffers the drawbacks of reliance on a centralized authority. A Key Distribution Center (‘KDC’) provides a method for communication between multiple nodes. The KDC establishes a key for use between the KDC and each node. Two nodes desiring to communicate with the other contact the KDC. The KDC generates a key for the communication between the two nodes and provides the key to the each node by encrypting the key with the node's KDC key. Thus, using a KDC, nodes desiring to communicate must contact the KDC to receive a key for each series of communications between the nodes. The use of a centralized KDC, therefore, may produce delays in processing requests because of bottlenecks occurring as a result of the KDC participating in many different transactions.

### SUMMARY OF THE INVENTION

Methods, systems, and products are disclosed for sending secured data, the method including encrypting a first portion of a request for computer services to be performed by a downstream node for decryption by a first node, encrypting a second portion of the request for computer services to be performed by a downstream node for decryption by a second node, and passing the request for computer services to a downstream node.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for sending secured data according to embodiments of the present invention.

FIG. 2 sets forth a block diagram illustrating an exemplary system of nodes in a multi-node transaction implementing a request for computer services according to embodiments of the present invention.

FIG. 3 sets forth a block diagram of automated computing machinery comprising an exemplary node useful in sending secured data according to embodiments of the present invention.

FIG. 4 sets forth a flow chart illustrating an exemplary method for sending secured data according to embodiments of the present invention.

FIG. 5 sets forth a flow chart illustrating a further exemplary method for sending secured data according to embodiments of the present invention.

### DETAILED DESCRIPTION OF EXEMPLARY EMBODIMENTS

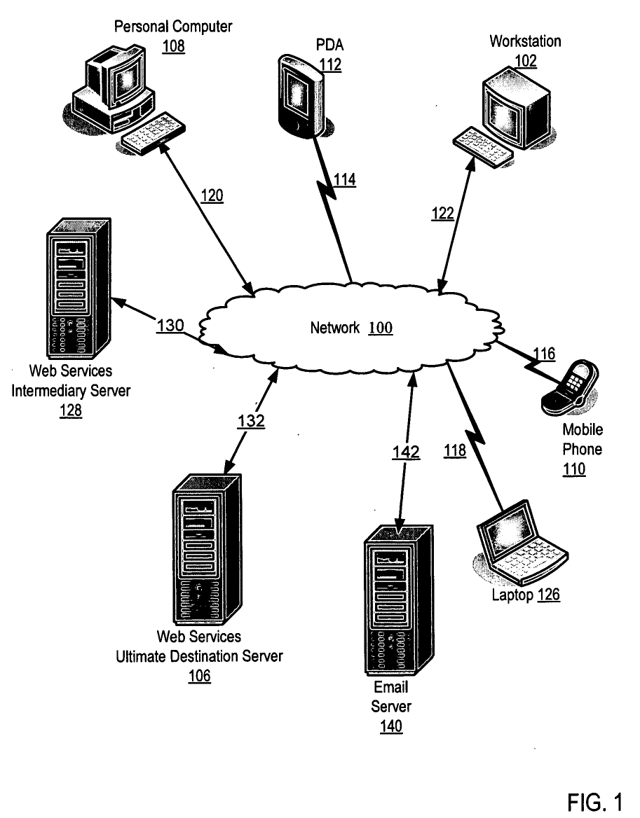

Exemplary methods, systems, and products for sending secured data according to embodiments of the present invention are described with reference to the accompanying drawings, beginning with FIG. 1. FIG. 1 sets forth a network diagram illustrating an exemplary system for sending secured data according to embodiments of the present invention. The system of FIG. 1 operates generally to send secured data according to embodiments of the present invention by encrypting a first portion of a request for computer services to be performed by a downstream node for decryption by a first node, encrypting a second portion of the request for computer services to be performed by a downstream node for decryption by a second node, and passing the request for computer services to a downstream node.

The system of FIG. 1 includes a data communications network. Network (100) provides data communications between initial requesters (102, 112, 108, 126, and 110) of computer services, intermediate nodes (128 and 140), and ultimate destination service providers (106, 140) in multiple-node transactions. The data passing through the network (100) may include sensitive data that passes through many nodes in the course of a multi-node transaction.

Initial requesters transmit requests for computer services to ultimate destination service providers for processing. A request for computer services is any request for processing to be performed by a computer. Such requests for computer services include a request for web services, a request for email to be passed on to another node, a request that an electronic document be passed to another node, a request for access to a database, a request for access to a file server, and other requests for processing to be performed by a computer as will occur to those of skill in the art. As discussed in more detail below, a request may be sent from the initial requester to the ultimate destination service providers through intermediary nodes which may perform additional processing on the request.

The term “web services” refers to a standardized way of integrating web-based applications. Web services typically provide business services upon request through data communications in standardized formats called bindings. A binding is a specification of a data encoding method and a data communications protocol. The most common binding in use for web services is data encoding in XML according to the SOAP protocol and data communications with HTTP. SOAP (Simple Object Access Protocol) is a request/response messaging protocol that supports passing structured and typed data using XML and extensions.

Web services are often delivered by use of multi-node transactions carried out through the used of web services intermediaries. Web services intermediaries are web services components, typically a server, that lies between a web services requester and a web services ultimate destination server that delivers the web service. Intermediaries operate generally by intercepting a request from a client, optionally providing intermediary services, and then forwarding the request to an ultimate destination web services provider (sometimes referred to as a ‘target service’). Similarly, responses from the web services provider (the target service) are intercepted, optionally operated upon, and then returned to the original requester.

The system of FIG. 1 includes several devices capable of supporting initial requesters. An initial requester of computer services is typically a data communications client, that is, any software capable of carrying out a transaction with an ultimate destination service provider by coupling for data communications to the ultimate destination service provider and transmitting a request to the ultimate destination service provider. Such initial senders are capable of transmitting a request for computer services to an ultimate destination service provider. Examples of devices capable of supporting initial requesters are personal computers, internet-enabled special purpose devices, internet-capable personal data administrators, and others that will occur to those of skill in the art. Such devices are capable of wired and/or wireless couplings to servers supporting transactions carried out through the use of multiple nodes. Devices capable of supporting initial senders in the system of FIG. 1 include:
workstation (102), a computer coupled to network (100) through wireline connection (122);
personal computer (108), coupled to network (100) through wireline connection (120);
personal digital assistant (112), coupled to network (100) through wireless connection (114);
laptop computer (126), coupled to network (100) through wireless connection (118); and
mobile phone (110), coupled to network (100) through wireless connection (116).

The system of FIG. 1 also includes several devices capable of supporting intermediary nodes useful in multi-node transactions. An intermediary node in a multi-node transaction is capable of receiving a request for computer services from another intermediary node or from the initial requester of computer services, optionally processing the request in part, and passing the request on to other intermediary nodes or to an ultimate destination service provider. An intermediary node may receive a request for computer services containing sensitive data, which is undesirable for the intermediary node to view. Devices capable of supporting intermediary nodes in the system of FIG. 1 include:
web services intermediary server (128), a computer coupled to network (100) through wireline connection (130); and
email server (140), a computer coupled to network (100) through wireline connection (142).

In the example of FIG. 1, web services intermediary server (128) is capable of acting as an intermediary node in a transaction for web services by receiving a request for web services from an initial requester or another intermediary web services provider and passing the request on to an ultimate destination web server or another intermediary web services provider. Similarly, in the example of FIG. 1, email server (140) is capable of acting as an intermediary node in email transactions. Email server (140) has installed an operative upon it software to receive email from clients and other email servers and to pass the email on to clients and to other email servers. The inclusion of web services intermediary servers and email servers are for explanation and not for limitation. In fact, intermediary nodes are useful in many contexts and all such intermediary nodes are included within the scope of the present invention.

Each of the devices of FIG. 1 capable of supporting initial senders and intermediary nodes have installed upon them a secure transmission module capable generally of encrypting a first portion of a request for computer services to be performed by a downstream node for decryption by a first node; encrypting a second portion of the request for computer services to be performed by a downstream node for decryption by a second node; and passing the request for computer services to a downstream node.

The system of FIG. 1 includes several devices capable of supporting ultimate destination service providers. Ultimate destination service providers receive requests for computer services over the network (100), process the requests, and may transmit responses over network (100). The system of FIG. 1 includes several devices capable of supporting ultimate destination service providers:
email server (140), coupled to network (100) through wireline connection (142), and
web services ultimate destination server (106), coupled to network (100) through wireline connection (132).

In the exemplary system of FIG. 1, web services ultimate destination server (106) is an ultimate destination service provider for web services. Web services ultimate destination server (106) has installed an operative upon it computer program instructions for providing web services are stored in a computer memory in web services server (106). In the exemplary system of FIG. 1, the email server (140) is also an ultimate destination service provider. Email server (140) of FIG. 1 has installed an operative upon it computer program instructions for receiving email from clients and other email servers and to ultimately making the email available to a requesting email client.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

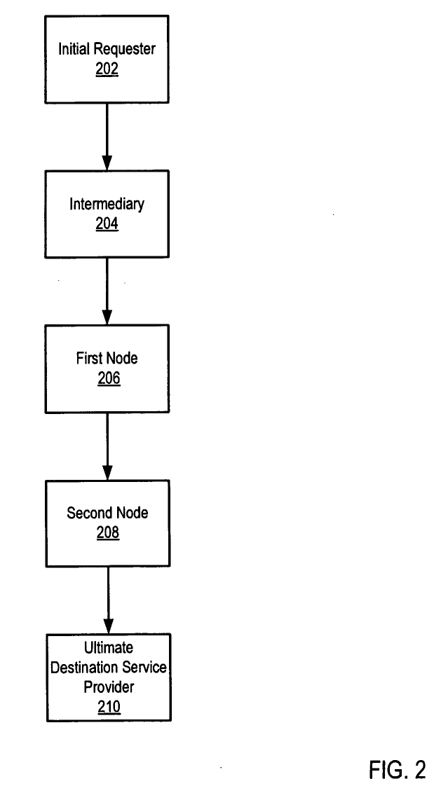

As explained above, a request for computer services may be implemented through a multi-node transaction, with the request being passed from node to node until it reaches an ultimate destination service provider. For further explanation, therefore, FIG. 2 sets forth a block diagram illustrating an exemplary system of nodes in a multi-node transaction implementing a request for computer services according to embodiments of the present invention. A node is typically implemented as an addressable device attached to a computer network. A node may be a computer, a mobile phone, a PDA, or any other device capable of attachment to a computer network that may occur to those of skill in the art. A node that receives a request for computer services before another node in a multi-node transaction is upstream of the other node with respect to a multi-node transaction. A node that receives a request for services after another node in a multi-node transaction is downstream of the node with respect to the multi-node transaction.

Each block in the example of FIG. 2 represents a node. Node (202) is an initial requester, a node that initiates a request for computer services. In the example of FIG. 2, the initial requester (202) sends the request for computer services to intermediary node (204). Intermediary node (204) is a node residing in the transaction between the initial requester (202) and the ultimate destination service provider (210). In the example of FIG. 2, the request for computer services is then passed from intermediary node (204) to another intermediary node, first node (206) and then on to still another intermediary node, second node (208). The intermediary nodes (204, 206, 208) may pass on the request for computer services without additional processing at the intermediary node or may perform additional processing on the requests at the intermediary node prior to passing on the request. The example of FIG. 2 also includes the passing of the request for computer services from intermediary node (208) to ultimate destination service provider (210). Ultimate destination service provider may finish providing the computer services requested by the initial requester (202).

All of the nodes (202, 204, 206, 208, and 210) in the system of FIG. 2 are improved to send secured data according to the present invention. For example, node (202) is improved to send secured data according to embodiments of the present invention by encrypting a first portion of a request for computer services to be performed by a downstream node for decryption by a first node (206), encrypting a second portion of the request for computer services to be performed by a downstream node (210) for decryption by a second node (208), and passing the request for computer services to a downstream node (204).

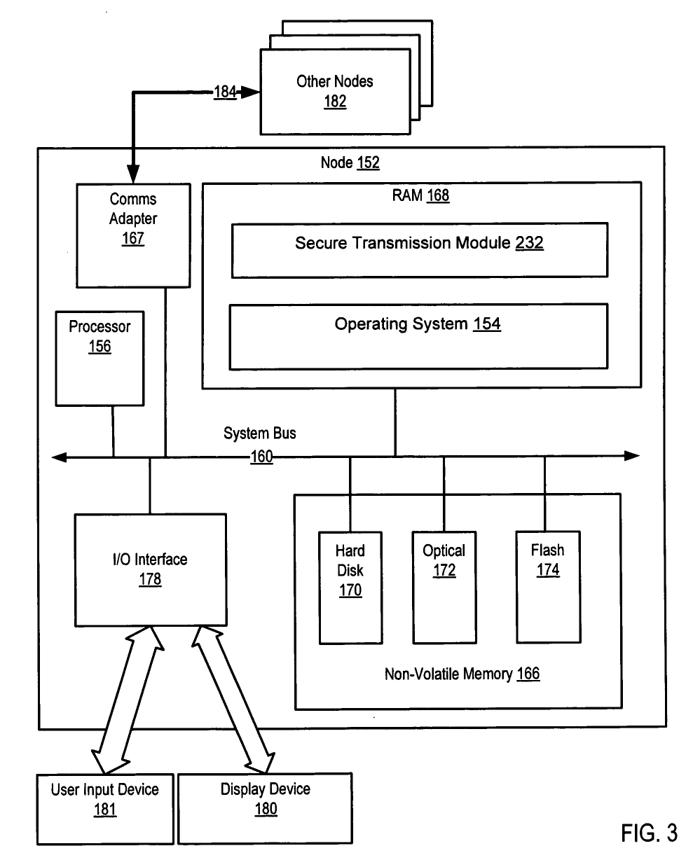

Sending secured data in accordance with the present invention is generally implemented with computers, that is, with automated computing machinery. In the system of FIG. 1, for example, all the nodes, servers, and communications devices are implemented to some extent at least as computers. For further explanation, therefore, FIG. 3 sets forth a block diagram of automated computing machinery comprising an exemplary node (152) useful in sending secured data according to embodiments of the present invention. The node (152) of FIG. 3 includes at least one computer processor (156) or ‘CPU’ as well as random access memory (168) (‘RAM’) which is connected through a system bus (160) to processor (156) and to other components of the computer.

Stored in RAM (168) is secure transmission module (232), computer program instructions for sending secured data according to embodiments of the present invention by encrypting a first portion of a request for computer services to be performed by a downstream node for decryption by a first node, encrypting a second portion of the request for computer services to be performed by a downstream node for decryption by a second node, and passing the request for computer services to a downstream node.

Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. Operating system (154) and secure transmission module (232) in the example of FIG. 3 are shown in RAM (168), but many components of such software typically are stored in non-volatile memory (166) also.

Exemplary node (152) of FIG. 3 includes non-volatile computer memory (166) coupled through a system bus (160) to processor (156) and to other components of the intermediary node (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary node of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary node (152) of FIG. 3 includes a communications adapter (167) for implementing data communications (184) with other nodes (182), including other intermediary nodes, initial requesters, and ultimate destination service providers. Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for sending secured data according to embodiments of the present invention include modems for wired dial-up communications, Ethernet (IEEE 802.3) adapters for wired network communications, and 802.11b adapters for wireless network communications.

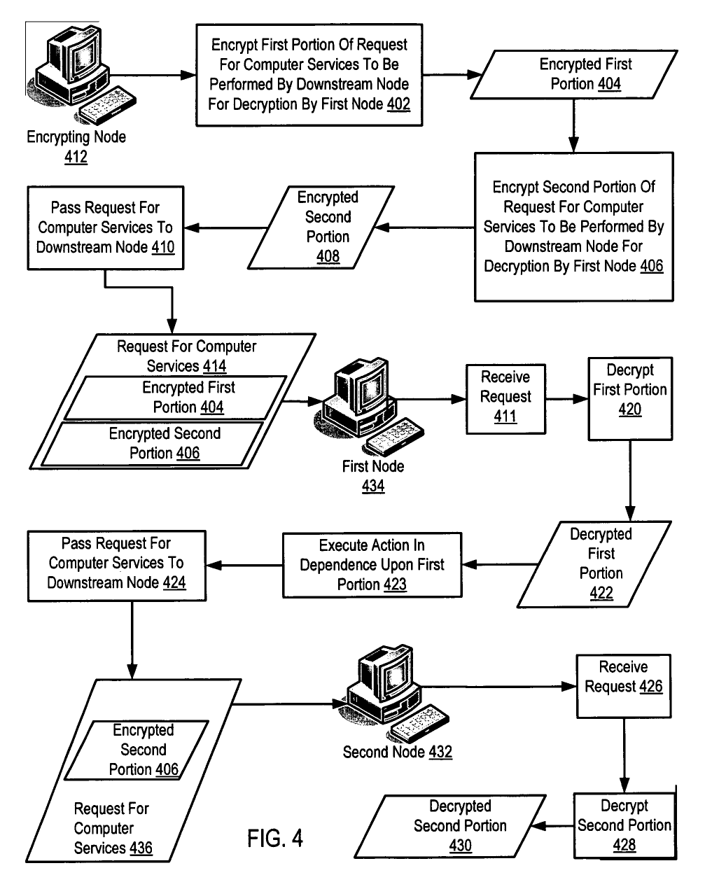

For further explanation, FIG. 4 sets forth a flow chart illustrating an exemplary method for sending secured data according to embodiments of the present invention that includes encrypting (402) a first portion of a request (414) for computer services to be performed by a downstream node for decryption by a first node (434), thereby producing an encrypted first portion (404). The process of encrypting information involves applying an algorithm to the information to convert the information to an unintelligible form. The process of undoing the encryption process to obtain the original information is known as decryption. Typical encryption and decryption algorithms involve the use of a secret, known as a key. Some algorithms use one secret key which is shared between the party, such as a node, which encrypts information and the party, such as another node, which decrypts the encrypted information. Other algorithms use a pair of keys, a private key and a public key.

Information encrypted with one key from the pair can be decrypted by the other key from the pair. Typically, only one party possesses the private key from a pair and multiple parties possess the public key. Commonly used encryption algorithms include 3DES (Data Encryption Standard), CAST-128, Twofish, and Advanced Encryption Standard (AES).

Encrypting (402) a first portion (404) of a request for computer services to be performed by a downstream node for decryption by a first node (434) according to the method of FIG. 4 may be carried out by selecting sensitive data in the request for computer services to be handled by a first node (434) as part of the processing involved in the request for computer services, selecting an encryption method to encrypt the first portion to produce encrypted data that can be decrypted by the first node (434) but typically not by other nodes, and encrypting the selected sensitive data by the selected encryption method. Encrypting the first portion of the request may be carried out by encrypting the first portion using a secret key shared only with the first node (434).

Alternatively, encrypting the first portion of the request for computer services may be carried out by encrypting the second portion using the first node's public key in the pubic key private key infrastructure. Encrypting the first portion of the request with the public key for the first node may be carried out by obtaining the public key of a public key/private key pair and encrypting the first portion of the request for computer services with the public key in accordance with an encryption algorithm. A public key and private key may be obtained from a key server. A key server is a computer running software which provides keys to users or other programs. A key server may generate a public key/private key pair, provide the private key to one node, and make the public key available to multiple nodes.

The method of FIG. 4 also includes encrypting (406) a second portion of the request for computer services to be performed by a downstream node for decryption by a second node (432), thereby producing an encrypted second portion (408). Encrypting (406) a second portion of a request for computer services to be performed by a downstream node for decryption by a second node (432) according to the method of FIG. 4 may be carried out by selecting sensitive data in the request for computer services to be handled by a second node (432) as part of the processing involved in the request for computer services, selecting an encryption method to encrypt the second portion to produce encrypted data that can be decrypted by the second node (432) but typically not by other nodes, and encrypting the selected sensitive data by the selected encryption method. Encrypting the second portion of the request may be carried out by encrypting the second portion using a secret key shared only with the second node (432). Alternatively, encrypting the second portion of the request for computer services may be carried out by encrypting the second portion using the second node's public key in the private key public key infrastructure.

The first node and second nodes may be any distinct nodes in the multi-node transaction invoked by the request for computer services. Either node, for example, may be an intermediate node or the ultimate destination service provider which is to complete the processing of the request for computer services. As illustrated in FIG. 4, the first node (434) is an intermediary node and the second node (432) is an ultimate destination service provider and the encrypting node (412) is an initial requestor of computer services.

The method of FIG. 4 also includes passing (410) the request (414) for computer services to a downstream node (434). Passing (410) the request (414) for computer services to a downstream node (434) may be carried out by selecting a downstream node to which to pass the request and transmitting the request to the node. Selecting a downstream node to which to pass the request may be carried out by selecting a downstream node addressed by the request, a downstream node looked up in a directory for the type of request, or a server to which the node (412) passing the request passes requests of the particular type corresponding with the request. Transmitting the request for computer services may be carried out by transmitting the request for computer services according to a protocol appropriate for the request. A request for web services, for example, may be sent and received according to SOAP. Mail messages, which represent requests for email services, are typically passed from one message transfer agent to another using SMTP.

The method of FIG. 4 also includes receiving (411) in the first node (434) the request (414) for computer services to be performed by a downstream node. Receiving (411) in the first node (434) the request (414) for computer services to be performed by a downstream node may be carried out by receiving the request according to the protocol by which the request was transmitted.

The method of FIG. 4 also includes decrypting (420) the encrypted first portion (404). Decrypting (420) the encrypted first portion (404) may be carried out by determining the method used to encrypt the first portion and applying a corresponding decryption method. Decrypting the encrypted first portion may be carried out by decrypting the encrypted first portion with the use of a secret key which was used to encrypt the first portion by application of a single-key encryption algorithm. Alternatively, decrypting the encrypted first portion may be carried out by decrypting the encrypted first portion with the first node's private key, when the first portion was encrypted with the first node's public key.

The method of FIG. 4 also includes executing (423) an action in dependence upon the first portion. Executing (423) an action in dependence upon the first portion may be carried out by performing a portion of the request for computer services in dependence upon information contained in the decrypted first portion and other information contained in the request (414) for computer services. Executing (423) an action in dependence upon the first portion may, for example, include performing partial processing on the request for computer services.

The method of FIG. 4 also includes passing (424) the request (436) for computer services to a downstream node (432). Passing (424) the request (436) for computer services to a downstream node (432) may be carried out by selecting a node to which to pass the request and transmitting the request to the selected node. Selecting a downstream node to which to pass the request may be carried out by selecting a downstream node addressed by the request, a downstream node looked up in a directory for the type of request, or a server to which the intermediary node passes requests of the particular type. Transmitting the request for computer services may be carried out by transmitting the request for computer services according to the protocol for the type of request.

The method of FIG. 4 also includes receiving (426) in the second node (432) the request (436) for computer services to be performed by a downstream node. Receiving (426) in the second node (432) the request (436) for computer services to be performed by a downstream node may be carried out by receiving the request according to the protocol by which the request was transmitted.

The method of FIG. 4 also includes decrypting (428) the encrypted second portion (408), thereby producing decrypted second portion (430). Decrypting (428) the encrypted second portion (408) may be carried out by determining the method used to encrypt the second portion and applying the corresponding decryption method. Decrypting (428) the encrypted second portion (408) may be carried out by decrypting the encrypting second portion with the use of a secret key which was used to encrypt the second portion by application of a single-key encryption algorithm. Alternatively, decrypting (428) the encrypted second portion (408) may be carried out by decrypting the encrypted second portion with the second node's private key, when the second portion was encrypted with the second node's public key.

In the example of FIG. 4, the second node (432) is the terminus in the transmission of the request for computer services. The second node (432) may, for example, be the ultimate destination service provider that finishes the processing of the request. The depiction of the second node (432) as the terminus in the transmission of the request for computer services in the example of FIG. 4 is for explanation, not limitation.

The second node (432) may pass along the request for computer services to yet another node for further processing or may pass along the results of the processing of the request for computer services to the original requestor or to another node, as will occur to those of skill in the art.

By including portions of the request for computer services in encrypted form, the method of FIG. 4 advantageously safeguards sensitive data from being viewed by parties other than the parties for which the data is intended (‘unintended parties’). An unintended party which obtained the encrypted data, either maliciously or by accident, could not make use of the encrypted information unless the unintended party possessed the means to decrypt the information.

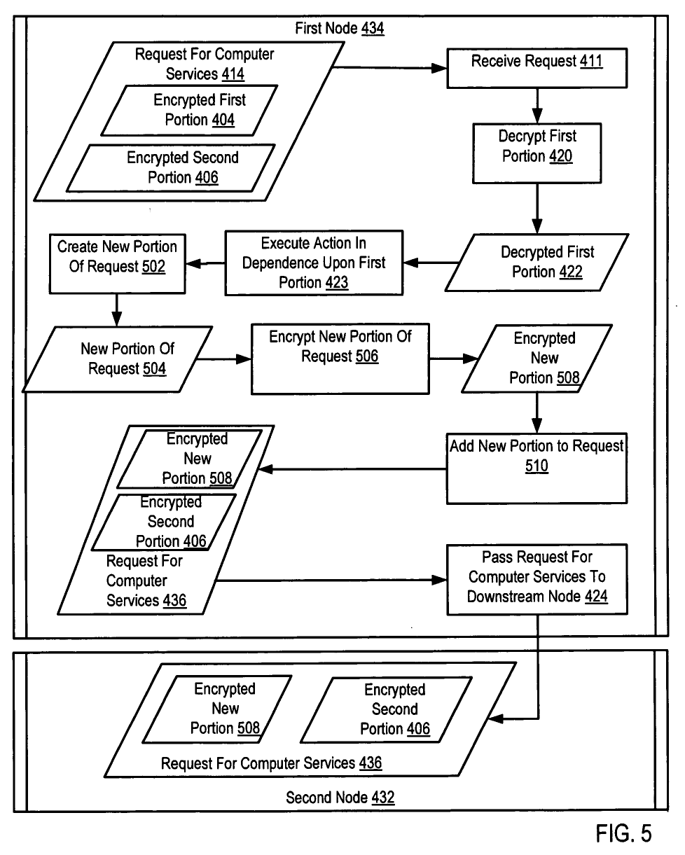

The use of encryption for safeguarding sensitive information is not limited to a single node in a multi-node transaction. For further explanation, then, FIG. 5 sets forth a flow chart illustrating an exemplary method for sending secured data according to embodiments of the present invention that includes encrypting a new portion of a request for computer services. The method of FIG. 5 includes receiving (411) in the first node (434) the request (414) for computer services to be performed by a downstream node. The request includes an encrypted first portion (404) and an encrypted second portion (408).

The method of FIG. 5 also includes decrypting (420) the encrypted first portion (404), thereby producing the decrypted first portion (422). Decrypting (420) the encrypted first portion (404) may be carried out by determining the method used to encrypt the first portion and applying the corresponding decryption method. Decrypting the encrypted first portion may be carried out by decrypting the encrypting first portion with the use of a secret key which was used to encrypt the first portion by application of a single-key encryption algorithm. Alternatively, decrypting the encrypted fist portion may be carried out by decrypting the encrypted first portion with the first node's private key, when the first portion was encrypted with the first node's public key.

The method of FIG. 5 also includes executing (423) an action in dependence upon the first portion. Executing an action in dependence upon the first portion may be carried out by performing a portion of the request for computer services in dependence upon information contained in the decrypted first portion and other information contained in the request (414) for computer services. Executing (423) an action in dependence upon the first portion may, for example, include performing partial processing on the request for computer services.

The method of FIG. 5, further includes creating (502) a new portion (504) of the request for computer services. Creating a new portion of the request may be carried out by identifying sensitive data to be handled by a downstream node as part of the processing involved in the request for computer services and including the sensitive data in the request.

The method of FIG. 5 also includes encrypting (506), by the first node (434), a new portion (504) of the request (414) for computer services to be performed by a downstream node, thereby creating an encrypted new portion (508). Encrypting a new portion of a request for computer services to be performed by a downstream node may be carried out by selecting sensitive data in the request for computer services to be handled by a downstream node as part of the processing involved in the request for computer services, selecting an encryption method to encrypt the new portion to produce encrypted data that can be decrypted by the downstream node but typically not by other nodes, and encrypting the selected sensitive data by the selected encryption method.

The method of FIG. 5 also includes adding the encrypted new portion (510) to the request for computer services, producing a modified request (436) for computer services which includes the encrypted second portion (408) and the encrypted new portion (508). The method of FIG. 5 also includes passing (424) the modified request (436) for computer services to a downstream node. In the example of FIG. 5, the first node (434) passes the modified request (436) for computer services to the second node (432).

The structure of the modified request for computer services and the node to which the modified request for computer services is passed in FIG. 5 are for explanation, not for limitation. The modified request may also include other portions, either encrypted or unencrypted or both as will occur to those of skill in the art.

Exemplary embodiments of the present invention are described largely in the context of a fully functional computer system for sending secured data. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethemets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A method for sending secured data, the method comprising:
encrypting a first portion of a request for computer services to be performed by a downstream node for decryption by a first node;
encrypting a second portion of the request for computer services to be performed by a downstream node for decryption by a second node; and
passing the request for computer services to a downstream node.

2. The method of claim 1 further comprising:
receiving in the first node the request for computer services to be performed by a downstream node;
decrypting the encrypted first portion; and
passing the request for computer services to a downstream node.

3. The method of claim 2 further comprising executing an action in dependence upon the first portion.

4. The method of claim 2 further comprising encrypting, by the first node, a new portion of the request for computer services to be performed by a downstream node.

5. The method of claim 1 further comprising:
receiving in the second node the request for computer services to be
performed by a downstream node; and
decrypting the encrypted second portion

6. The method of claim 1 wherein encrypting a first portion of a request for computer services to be performed by a downstream node for decryption by a first node further comprises encrypting the first portion of the request with the public key for the first node.

7. The method of claim 1 wherein the first node and the second node are intermediary nodes between an initial requestor of computer services and an ultimate destination service provider of the request.

8. A system for sending secured data, the system comprising:
a computer processor;
a computer memory operatively coupled to the computer processor, the computer memory having disposed within it computer program instructions capable of:
encrypting a first portion of a request for computer services to be performed by a downstream node for decryption by a first node;
encrypting a second portion of the request for computer services to be performed by a downstream node for decryption by a second node; and
passing the request for computer services to a downstream node.

9. The system of claim 8 wherein the computer memory also has disposed within it computer program instructions capable of:
receiving in the first node the request for computer services to be performed by a downstream node;
decrypting the encrypted first portion; and
passing the request for computer services to a downstream node.

10. The system of claim 9 wherein the computer memory also has disposed within it computer program instructions capable of executing an action in dependence upon the first portion.

11. The system of claim 9 wherein the computer memory also has disposed within it computer program instructions capable of encrypting, by the first node, a new portion of the request for computer services to be performed by a downstream node.

12. The system of claim 8 wherein the computer memory also has disposed within it computer program instructions capable of:
receiving in the second node the request for computer services to be performed by a downstream node; and
decrypting the encrypted second portion

13. The system of claim 8 wherein the computer memory also has disposed within it computer program instructions capable of encrypting the first portion of the request with the public key for the first node.

14. A computer program product for sending secured data, the computer program product disposed upon a signal bearing medium, the computer program product comprising computer program instructions capable of:
encrypting a first portion of a request for computer services to be performed by a downstream node for decryption by a first node;
encrypting a second portion of the request for computer services to be performed by a downstream node for decryption by a second node; and
passing the request for computer services to a downstream node.

15. The computer program product of claim 14 wherein the signal bearing medium comprises a recordable medium.

16. The computer program product of claim 14 wherein the signal bearing medium comprises a transmission medium.

17. The computer program product of claim 14 further comprising computer program instructions capable of:
receiving in the first node the request for computer services to be performed by a downstream node;
decrypting the encrypted first portion; and
passing the request for computer services to a downstream node.

18. The computer program product of claim 17 further comprising computer program instructions capable of executing an action in dependence upon the first portion.

19. The computer program product of claim 17 further comprising computer program instructions capable of encrypting, by the first node, a new portion of the request for computer services to be performed by a downstream node.

20. The computer program product of claim 14 further comprising computer program instructions capable of encrypting the first portion of the request with the public key for the first node.
